(19) United States
(12) Patent Application Publication
(10) Pub. No.: US 2005/0067989 A1
(43) Pub. Date: Mar. 31, 2005

(54) Method for end-of travel learning and device therefor

(75) Inventors: Eric Lagarde, Sallanches (FR); Serge Bruno, Marnaz (FR)

Correspondence Address: John L Rogitz;Rogitz & Associates, 750 B Street, Suite 3120, San Diego, CA, 92101, US

(73) Assignee: SOMFY SAS, 74300 Cluses (FR)

(21) Appl. No.: 10/497,965

(22) PCT Filed: Dec. 9, 2002
(86) PCT No.: PCT/IB02/05188

(30) Foreign Application Priority Data
Dec. 10, 2001 (FR) 01/15930

(51) Int. Cl. H02P 3/00

(52) U.S. Cl. 318/466

(57) ABSTRACT

The learning process comprises at least the succession of the following steps: positioning of the product in a first limit of travel position; storage of the position of the product; command of displacement of the product to a second limit of travel position determined by an end stop; identification of the second limit of travel position; storage of the position of the product; analysis of the kinematic link between the actuator and the movable product in the vicinity of the first position.

The invention relates to a process for learning the limits of travel of a movable product displaced by means of an actuator, at least one of the limits of travel of which is determined by an end stop.

The invention also relates to a device allowing the implementation of the learning process.

Patents relating to devices or processes for learning the limits of travel exist in the prior art.

French patent FR 2 743 602 relates to a motorized closure or solar protection installation. In this patent, the existence of two end stops, top and bottom, is assumed. The aim is to distinguish these stops from an obstacle or else from a defect such as a hard point in a slideway. The use of a bidirectional counter (incrementation decrementation) is proposed in association with a means for measuring variations in speed or in torque. The learning process described exploits the existence of end stops but there is no specific indication of the bottom position by the installer.

In French patent FR 2 754 117 pertaining to a roller blind or shutter control device, the existence of two end stops is likewise assumed. The procedure described is that of an automatic sequence aimed at assigning the right direction of motor rotation in response to an order given from the control point. In the course of this procedure, the product starts automatically on encountering the first and then the second stop. A comparison of the durations of displacement between the ends of travel is made, and the position of the stops is possibly recorded automatically. The learning process used therefore exploits the existence of end stops. There is no specific indication of the bottom position by the installer.

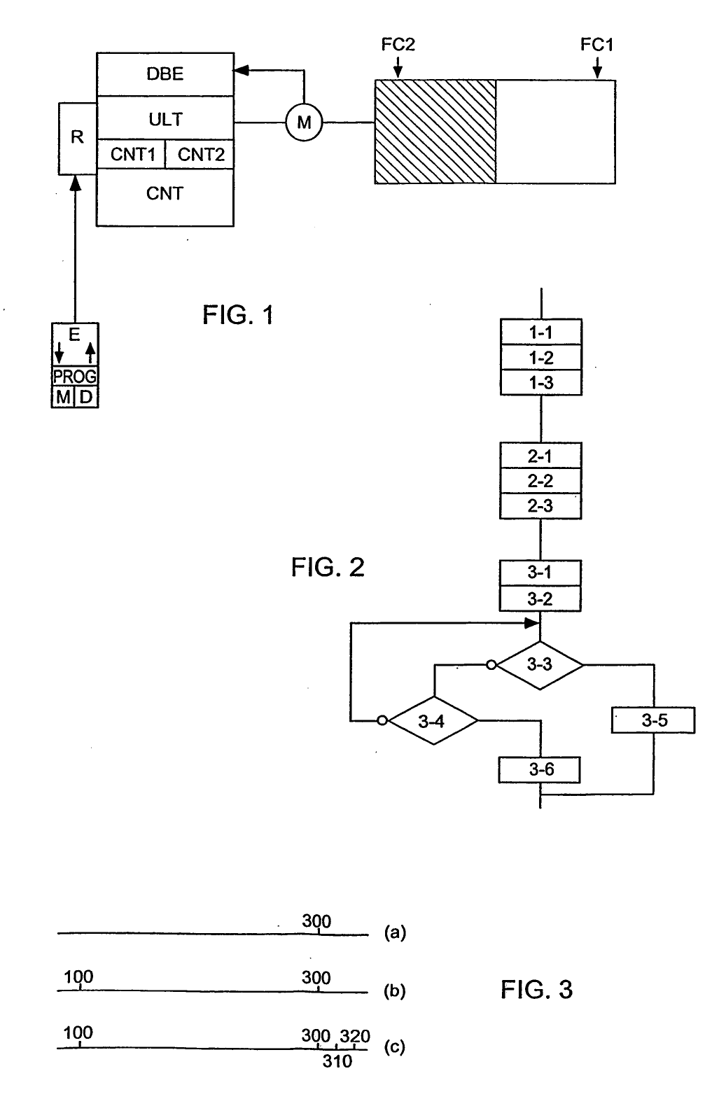

French patent FR 2 780 089 describes a roller blind drive motor control device. This patent addresses the desire to produce an automatic adjustment device making it possible to identify the bottom position, and the nature of the link between the actuator (or the winding tube) and the blind. For this purpose, the device comprises at least means of fine analysis of variations in the motor torque. These means are represented in FIG. 1 and comprise at least one sensor (1) for example a sensor of “micro-displacements” and an analog/digital converter (2). FIG. 2 of this patent clearly shows the type of analysis of variations in torque necessary, and therefore the accuracy of the measuring device. The application of the algorithms presented in this patent is therefore necessarily expensive. There is no specific indication of the bottom position of the roller blind by the installer.

French patent FR 2 790 787 pertains to a device for detecting the termination of stacking of the slats of a roller blind. This patent describes more particularly the difficulties in detecting termination of stacking of the slats of a roller blind when dealing with wind-up slats. As before, the torque detection is carried out by means of a sensor responsive to “micro-displacements”. The termination of stacking is detected by the closing of an angular clearance. Despite its advantages, this invention therefore requires both the above sensor and its processing electronics, and also a specific mechanical setup for creating the angular clearance. There is no specific indication of the bottom position of the blind by the installer, nor correlation of the detection of micro-displacement with a particular value of a displacement counter.

French patent application FR 2 808 835 presents the particular feature of proposing a process of adjustment in which a second limit of travel is stored implicitly after the first limit of travel has been recorded, either automatically (in the case of an end stop), or through a manual procedure. Therefore, in the case (cf. page 9 line 27) of a product exhibiting a single end stop allowing automatic adjustment (for example top stop), the process according to this application would require the installer to:
activate the automatic mode of adjustment and send the product to its end stop by pressing the up button, until the automatic recording of the top limit of travel position is triggered.
take command by controlling the product until it is brought to its desired bottom position,
and again send the product back to the top stop, this maneuver having the aim of recording the bottom position.

It appears that this “non-automatic” way of recording the position is surprising and sufficiently contrary to intuition as to confuse installers and cause a loss of time on work sites. Moreover, this process prevents a fast installation procedure since it obliges the installer to trigger the automatic recording of the stop before repositioning the product on the stopless position.

The situation thus transpires in which there exist, on the one hand, devices which are simple but which can be applied only to products exhibiting two end stops, while there exist, on the other hand, devices that are much more complex as regards accuracy required on the part of sensors and of measurement and software processing facilities.

The aim of the invention is consequently to improve the known processes and devices.

More particularly, the invention is aimed at remedying the drawback indicated above by proposing a novel process of semi-automatic type, allowing one and the same actuator to drive products of different kind, as long as these products comprise at least one end stop.

The process according to the invention is characterized by the succession of the following steps is carried out:
positioning of the product in a first limit of travel position;
storage of the position of the product;
command of displacement of the product to a second limit of travel position determined by an end stop;
identification of the second limit of travel position;
storage of the position of the product;
analysis of the kinematic link between the actuator and the movable product in the vicinity of the first position so as to select a strategy for maneuvering the actuator in response to a later command of positioning of the movable product in the first position.

Preferably, the analysis of the kinematic link comprises at least the following steps:
command of displacement of the movable product to the first limit of travel position;
overstepping of said first position;
during the overstepping, verification of the presence of a stop;
if a stop is detected, halting of the product and storage of its position;
if no stop is detected, halting of the product when a predetermined position, calculated on the basis of the first position is reached and storage of this predetermined position.

According to a first variant of execution of the process, the sequence of said steps takes place in a continuous manner. This first variant of the process allows the installer to make sure, if he so wishes, that the mode of learning is accomplished in its entirety.

According to a second variant of the process, the sequence of said steps takes place in a discontinuous manner. This second variant of the process makes it possible, for example, to defer the entirety of the learning, when fast installation is sought.

According to a preferred mode of execution, the storage of the position of the product is performed through the association of the position of the product with a numerical value and the storage of said numerical value. Said stored numerical value can be corrected by a predetermined quantity.

The device for the implementation of the process is one wherein the device comprises at least a transmitter, a receiver linked to an actuator controlling a motor acting on a movable product, said actuator comprising a counter, a logic processing unit associated with at least two memories, whose stored values correspond to values of the counter identifying limits of travel of the movable product, and a stops detector.

Preferably, the movable product is a roller blind, the first position is a closed position and the second position is an open position.

These blinds generally comprise a top mechanical stop, which holds back the shutter curtain onwards of a certain winding level. This stop is easily detectable by the detection means placed in the actuator (measurement of variation of torque or of load, measurement of variation of speed, etc.).

On the other hand, as far as the bottom point is concerned, an end stop will be found only in certain situations corresponding to a bracing mechanism allowing linkage between shutter curtain and winding tube. These mechanisms are known as locks: when the blind is in the completely unwound position and the actuator is continuing its rotational motion, the lock becomes braced and exerts strong pressure on the entire shutter curtain, thereby preventing any fraudulent lifting of the latter from outside. Adjustment of bracing is an essential condition for the proper operation of such a mechanism. For these products it is therefore necessary for the actuator to overstep the position corresponding to the bottom position, so as to exert the pressure desired in order to cause bracing.

Other links between the winding tube and the shutter curtain do not exhibit this kind of end stop in the bottom position: they simply involve foil strips, or webbing. In this case, significant overstepping of the bottom position is precluded, otherwise it might cause unfastening of the links, stressing of the blind against the walls of the box, or reverse winding.

The description of the invention is given hereinbelow in the case of a roller blind with stackable slats, but it is clear that the invention applies in the same manner to any actuator intended to be mounted on movable products for closure, for shading or for solar protection, of a different kind but characterized by at least one end stop. The displacement of these products in space may either be horizontal, inclined or vertical.

The block diagram of a device allowing the implementation of the process according to the invention is described firstly with reference to FIG. 1. This device comprises a transmitter E, a receiver R, these two elements forming a control facility E/R, a logic processing unit ULT associated with an incrementation decrementation counter CNT (depending on the direction of control of the actuator) whose particular values may be stored either on the basis of the E/R control, or on the basis of the signal of a stop detector DBE in memories CNT1, CNT2. Of course, the actuator also comprises a motor M which actually drives the movable product controlled by the ULT. Such logic processing units are known in the state of the art, in particular from the prior publications indicated above.

A mode of execution of the process according to the invention is described more particularly with reference to FIGS. 2 and 3.

In a first phase (Phase 1), split into three subphases, 1.1 to 1.3:
phase 1.1: the installer acts firstly on the control facility until reaching a first limit of travel position FC1, for example, in the case of a roller blind with stackable slats, this position corresponds to a “closed, or full shading” position of the blind and all the visible slats are stacked. It should be pointed out that this position is very often the initial position during an assembly procedure since the shutter curtain rests on the bottom part of the bay, and that the installer then fixes the top slats to the winding tube. By way of example, it is assumed that the state of the counter in this position is 300 (see also FIG. 3, line (a));
phase 1.2: the installer then uses the control facility (transmitter E) to send a specific order to store this first position. Preferably, this specific order is given by an explicit combination of two buttons: a so-called programming button PROG and a button (U: up) or (D: down) indicating the position of the limit of travel, in the present case D. For translation, the buttons (L: left) or (R: right) would be involved;
phase 1.3: on receipt of this command, the ULT proceeds to the recording of the value of the counter CNT in the first memory CNT1.

Onwards of this instant, subsequent adjustment becomes independent of the installer.

In a second phase (Phase 2), split into three subphases 2.1 to 2.3:
phase 2.1: the actuator starts in the direction allowing the product to be driven towards the end stop;
phase 2.2: the detector (DBE) detects this stop and the ULT causes the actuator to halt;
phase 2.3: the ULT records the content of the counter CNT in a second memory CNT2.

By way of example, it may be assumed that CNT2 equals 100 (see FIG. 3, line (b)).

In a third phase (Phase 3), the following steps are carried out:
step 3.1: the actuator starts in the direction allowing a return to the position FC1;
step 3.2: having reached FC1, the actuator oversteps this position. The maximum permitted overstep is fixed at a predetermined value DMAX;
step 3.3: in the course of the overstepping movement, the sensor DBE analyses the possible presence of a stop. If such a stop is detected, then the ULT management program goes to step 3.5, otherwise,
step 3.4: in the course of the overstepping movement, the ULT tests whether the current position of the counter remains less than CNT1 plus the value DMAX. (For example, DMAX=20). If such is indeed the case, the program loops back to subphase 3.3, otherwise, it is step 3.6 with halting of the motor and exiting from the initialization program;
in step 3.5: there is halting of the motor, replacement of CNT1 by the current value of the counter CNT and exiting from the initialization program. For example, the new value of CNT1 is now 310.

Subsequently, the limits of travel used are dictated by the contents CNT1 and CNT2.

As is known to the person skilled in the art, it is often useful to halt the movement towards the end stop slightly before the recorded value CNT2 to prevent unnecessary stress on the product. Likewise, it is entirely possible to halt the movement slightly before CNT1 in the case of a rigid link or of a lock that should not be overly compressed. Thus, it may be useful to decrease the value stored by a predetermined quantity so as to carry out early halting such as this.

It will be noted that entry to phase 3.5 corresponds for example to a blind with bracing lock, whereas entry to phase 3.6 corresponds to a blind with simple linkage (webbing or foil strip).

As indicated already, the process according to the invention can take two variants:
in a first variant, phases 2.1 and 3.1 correspond to movements triggered by the ULT by stringing together the previous phases and without intervention from the user,
in a second variant, these phases are not triggered automatically, but result from successive commands triggered by the installer or subsequently by the user and bringing the product to the stop FC2 for a first time and then to the position FC1 for a second time. Any number of orders to move in one or the other direction can then be interposed between these events giving rise to a resumption of the initialization program.

1. A process for learning the limits of travel of a movable product displaced by means of an actuator, at least one of the limits of travel of which is determined by an end stop, said process being one wherein the succession of the following steps is carried out:
positioning of the product in a first limit of travel position;
storage of the position of the product;
command of displacement of the product to a second limit of travel position determined by an end stop;
identification of the second limit of travel position;
storage of the position of the product;
analysis of the kinematic link between the actuator and the movable product in the vicinity of the first position so as to select a strategy for maneuvering the actuator in response to a later command of positioning of the movable product in the first position.

2. The learning process as claimed in claim 1, wherein the analysis of the kinematic link comprises at least the following steps:
command of displacement of the movable product to the first limit of travel position;
overstepping of said first position;
during the overstepping, verification of the presence of a stop;
if a stop is detected, halting of the product and storage of its position;
if no stop is detected, halting of the product when a predetermined position, calculated on the basis of the first position is reached and storage of this predetermined position.

3. The learning process as claimed in one of claims 1, wherein the sequence of said steps takes place in a continuous manner.

4. The learning process as claimed in claim 1, wherein the sequence of said steps takes place in a discontinuous manner.

5. The learning process as claimed in claim 1, wherein the storage of the position of the product is performed through the association of the position of the product with a numerical value and the storage of said numerical value.

6. The learning process as claimed in claim 1, wherein said stored numerical value is corrected by a predetermined quantity.

7. The learning process as claimed in claim 1, wherein the movable product is a roller blind, the first position is a closed position and the second position is an open position.

8. A device for the implementation of the process as claimed in claim 1, wherein the device comprises at least a transmitter (E), a receiver (R) linked to an actuator controlling a motor (M) acting on a movable product, said actuator comprising a counter (CNT), a logic processing unit (ULT) associated with at least two memories (CNT1, CNT2), whose stored values correspond to values of the counter identifying limits of travel of the movable product and a stops detector (DBE).
